(19) United States
(12) Patent Application Publication
(10) Pub. No.: US 2003/0126791 A1
(43) Pub. Date: Jul. 10, 2003

(54) Low profile commercial greenhouse

(76) Inventor: Donald E. Weder, Highland, IL (US)

Correspondence Address: DUNLAP, CODDING & ROGERS P.C., PO BOX 16370, OKLAHOMA CITY, OK, 73114, US

(21) Appl. No.: 10/301,467

(22) Filed: Nov. 20, 2002

Related U.S. Application Data
(63) Continuation-in-part of application No. 09/565,033, filed on May 3, 2000, now abandoned.

(51) Int. Cl. A01G 9/00

(52) U.S. Cl. 47/17

(57) ABSTRACT

A low profile commercial greenhouse is provided which is adapted for growing plants, as well as methods for using same. The low profile commercial greenhouse includes a housing having an upper end, a lower end, and a plant retaining space, wherein the plant retaining space has a height sufficient to provide a predetermined amount of spatial clearance between the upper end of the housing and an upper end of living items growing therein to permit circulation of air and other fluids about at least a portion of the living items. The housing of the low profile commercial greenhouse may be provided with a lid or door therein for accessing the plant retaining space, and one or more apertures may be formed in the housing for modifying the atmosphere contained therein. The low profile commercial greenhouse may be provided with a conveyor disposed therein for conveying items within the plant retaining space of the housing such that the items are provided with more uniform exposure to light.

### CROSS REFERENCE TO RELATED APPLICATIONS

This application is a continuation-in-part of U.S. Ser. No. 09/565,033, filed May 3, 2000, now abandoned.

### STATEMENT REGARDING FEDERALLY SPONSORED RESEARCH OR DEVELOPMENT

Not Applicable.

### BACKGROUND OF THE INVENTION

1. Field of the Invention

The present invention relates generally to greenhouses adapted for growing plants and methods for using same, and more particularly, but not by way of limitation, to a low profile commercial greenhouse adapted for growing plants and methods for using same.

2. Brief Description of the Art

Greenhouses, which provide an environment which assists in facilitating the growth of many types of vegetation, are well known in the art. Greenhouses are generally of a sufficient height to allow a grower of plants access to the plants growing inside by physically entering and exiting the greenhouse. Although this height allows the grower to manipulate the plants growing inside the greenhouse in various ways, several problems arise from the size required for greenhouses constructed in this manner.

A ventilated heating and cooling system may be installed to compensate for variations from the desired interior temperature, but the operating costs and requirements for creating and maintaining a suitable environment within the greenhouse can be both energy inefficient and prohibitively expensive. This problem arises not only from the volume of the area to be heated or cooled, but also from the fact that these structures are typically not tightly constructed and well-insulated. These structures are also susceptible to hail and windstorm damage.

In addition, light filtered through the exposed surfaces of the greenhouse may not be provided uniformly to all areas of the greenhouse, and plants sitting stationary in one area of the greenhouse may receive adequate lighting while plants sitting stationary in another area may not receive adequate lighting. The lack of uniformity in heating, lighting and air conditioning results in plants maturing at different growth rates and possibly even lack of blooming in plants which do not receive adequate lighting. Often plant sales are dependent upon a particular season or holiday, and therefore new and improved methods of growing plants so that they will mature at a consistent rate and in a desired time period are continually being sought.

Another problem stemming from the large volume which must be maintained in a typical greenhouse involves the application of various disinfectants, such as herbicides, pesticides and fungicides, and/or growth regulators to plants growing within the greenhouse. The application of such chemicals to plants growing within the greenhouses is heavily regulated and requires that human exposure to these chemicals be limited. Protective gear is required to be worn during application of such chemicals, and the greenhouse cannot be entered until the chemicals are exhausted from the greenhouse; this exhaustion results in emission of the toxic substances into the atmosphere surrounding the greenhouse. Further, the amount of chemicals required for fogging the entire space within the greenhouse can be very expensive.

Other greenhouses of the prior art which do not require a grower of plants to physically enter the greenhouse include terrariums, various types of window boxes, hot boxes and covers for field crops. However, terrariums and window boxes are not feasible for growth of plants on a commercial or industrial scale. Covers for field crops are used temporarily, such as for protection from freezing, do not provide the degree of light and climate control and uniformity possible in a greenhouse, and are not used as a permanent method for growth of plants in a greenhouse.

While the prior art greenhouses have been widely accepted, new and improved greenhouses having improved light, temperature and environmental control as well as reduced construction, energy and labor costs are being sought. It is to such greenhouses and methods for growing plants within same that the present invention is directed.

### SUMMARY OF THE INVENTION

According to the present invention, a low profile commercial greenhouse is provided which is adapted for growing plants, as well as methods for using same. Broadly, the low profile commercial greenhouse includes a housing defining a plant retaining space which wholly or partially contains the plant(s) or other organisms. The plants or organisms are retained in the housing, which may be a structure of any shape, including but not limited to, cylindrical, tubular and polygonal configurations. The plant retaining space of the housing is adapted to receive plants and has a sufficient height to provide a predetermined amount of spatial clearance between the upper end of the housing and an upper end of plants growing therein to permit circulation of air and other fluids about at least a portion of the plants growing therein.

A portion of the housing of the low profile commercial greenhouse may be is movable independently of the rest of the housing, thereby forming a lid or door which allows a grower of plants, maintenance person or other individual access to the plant retaining space of the housing of the low profile commercial greenhouse without requiring physical entry into the plant retaining space of the housing of the low profile commercial greenhouse. However, it is to be understood that entry of personnel may be provided in the lower profile commercial greenhouse.

One or more apertures may also be provided in the housing to allow injection or removal of water and/or chemicals such as insecticides or fungicides, or which allow for varying atmospheric conditions in the plant retaining space of the housing of the low profile commercial greenhouse. The aperture may also allow extraction of atmospheric samples or exhaustion of the plant retaining space of the housing of the low profile commercial greenhouse.

The low profile commercial greenhouse may further include a conveyor system disposed in the plant retaining space of the housing for moving plants in the plant retaining space of the housing and to enhance insertion and/or removal of the plants from the housing of the low profile commercial greenhouse. The housing may be provided with one or more openings through which the conveyor system extends, thereby providing an entry and/or an exit for plants from the plant retaining space of the housing of the low profile commercial greenhouse.

Broadly, the present invention also includes a method for growing plants, which includes providing a low profile commercial greenhouse and a plant or other article to be grown therein, disposing the plant or other article to be grown in the plant retaining space of the housing of the low profile commercial greenhouse, feeding and watering the plant or other article to be grown within the low profile commercial greenhouse until the plant or other article matures to a marketable size or to a size requiring processing in another manner or larger house, and removing the plant or other article from the housing of the low profile commercial greenhouse. When the low profile commercial greenhouse is provided with a conveyor system, the plant may be conveyed through the opening in the housing for entry of the plant into the plant retaining space of the housing or for exit of the plant therefrom. Plants growing in the low profile commercial greenhouse provided with a conveyor system may also be rotatably conveyed within the plant retaining space of the housing of the low profile commercial greenhouse so that the plants are provided with more uniform exposure to light.

Alternatively, the low profile commercial greenhouse need not be equipped with a conveyor system for conveying the plant and/or other article growing therein. Such low profile commercial greenhouse may be loaded and unloaded manually or using other mechanical methods.

An object of the present invention is to provide a low profile commercial greenhouse adapted for growing plants therein.

Another object of the present invention, while achieving the before-stated object, is to provide methods for growing plants in a low profile commercial greenhouse.

Other objects, features and advantages of the present invention will become apparent from the following detailed description when read in conjunction with the accompanying drawings and appended claims.

### BRIEF DESCRIPTION OF THE DRAWINGS

FIG. 1 is a pictorial representation of a low profile commercial greenhouse constructed in accordance with the present invention.

FIG. 2 is a pictorial representation of another embodiment of a low profile commercial greenhouse constructed in accordance with the present invention.

FIG. 3 is a pictorial representation of yet another embodiment of a low profile commercial greenhouse constructed in accordance with the present invention.

FIG. 4 is a pictorial representation of another embodiment of a low profile commercial greenhouse constructed in accordance with the present invention.

FIG. 5 is a pictorial representation of an embodiment of a low profile commercial greenhouse constructed in accordance with the present invention wherein a conveyor is disposed in a plant retaining space of the low profile commercial greenhouse.

FIG. 6 is a pictorial representation of the low profile commercial greenhouse of FIG. 5 connected to a pot filling system, a planting system and a packaging system which are also involved in the process of growing plants and preparing plants for distribution and sale.

FIG. 7 is a pictorial representation of another embodiment of a low profile commercial greenhouse constructed in accordance with the present invention wherein a base of the low profile commercial greenhouse is supported on a conveyor.

FIG. 8 is a pictorial representation of a low profile commercial greenhouse similar to the low profile commercial greenhouse of FIG. 1, except that the low profile commercial greenhouse is supported on a conveyor which is provided with a track.

FIG. 9A is a pictorial representation of another embodiment of a low profile commercial greenhouse constructed in accordance with the present invention, wherein the low profile commercial greenhouse is in an inflated condition and provided with a cylindrical shape.

FIG. 9B is a pictorial representation of the low profile commercial greenhouse of FIG. 9A in a deflated condition.

FIG. 10 is a pictorial representation of another embodiment of a low profile commercial greenhouse constructed in accordance with the present invention, wherein the low profile commercial greenhouse is provided with a polygonal shape.

FIG. 11 is a pictorial representation of a top planar view of another embodiment of a low profile commercial greenhouse constructed in accordance with the present invention, wherein the low profile commercial greenhouse may be moved from position to position to rotate plants contained therein.

FIG. 12 is a pictorial representation of a cross sectional view of another embodiment of a low profile commercial greenhouse constructed in accordance with the present invention, wherein the low profile commercial greenhouse may be rotated from position to position to rotate plants contained therein.

### DETAILED DESCRIPTION OF THE INVENTION

The present invention relates to a low profile commercial greenhouse which avoids many of the disadvantages and defects of the prior art commercial greenhouses. The larger structures of the prior art exchange more heat than the smaller structures of the present invention, thereby increasing heating and cooling costs. Reduced energy requirements for heating and cooling the low profile commercial greenhouse of the present invention will in some instances permit growing plants and other organisms closer to market, thereby reducing transport costs and improving freshness. In addition, the lower cost construction and maintenance costs of the low profile commercial greenhouse described herein makes the use of plants to remove pollutant materials from air more practical, and thus the greater economics lends itself to use as a means of industrially cleaning air of pollutants.

The low profile commercial greenhouse comprises a structure or housing providing a plant retaining space that is defined by the housing or structure. The housing or structure may fully or partially enclose the plant retaining space. The plant retaining space may contain plants or any organism to be grown or cultured. The plant retaining space enclosed partially or completely by the housing or structure is adapted to receive plants and has a sufficient height to provide a predetermined amount of spatial clearance between an upper end of the housing and an upper end of plants growing therein to permit circulation of air and other fluids about the contents of the plant retaining space, including but not by way of limitation, the plants, growing media and plant containers as well as other organisms growing therein. The height of the plant retaining space allows a grower of plants access to plants growing within the plant retaining space of the housing from without, rather than requiring the grower of plants to physically enter the plant retaining space of the low profile commercial greenhouse to access the plants. The low profile commercial greenhouse is therefore sufficiently shorter in height and may be more tightly constructed than the commercial greenhouses of the prior art. The low profile commercial greenhouse will therefore be subject to reduced hail and windstorm damage than the greenhouses of the prior art. Construction of the low profile commercial greenhouse will require less materials and labor than the greenhouses of the prior art, resulting in reduced structural cost and labor expense, as well as ease of maintenance and cleaning. The tighter construction will permit more efficient light, temperature and environmental control, as well as reduced cost for such control. The tighter construction of the low profile commercial greenhouse will also facilitate the production of uniform conditions within the plant retaining space. Further, the amount of chemicals such as disinfectants and growth regulators required for application to plants growing within the low profile commercial greenhouse will be substantially reduced, resulting in reduced expense as well as smaller emissions of toxic substances into the environment. In addition, human exposure to such chemicals and the attendant social and economic costs associated therewith can be eliminated.

The low profile commercial greenhouse may include a conveyor system disposed in the plant retaining space of the housing for conveying plants to a desired position therein. The housing may be provided with at least one opening through which the conveyor system extends, thereby providing an entry and/or an exit for plants from the plant retaining space of the housing of the low profile commercial greenhouse. The conveyor system will allow for ease of automation of steps in the method of growing plants within the low profile commercial greenhouse. For example, variables within the low profile commercial greenhouse, such as light, temperature and environment, may be controlled through apertures disposed in the upper end or the sidewall of the low profile commercial greenhouse, thereby eliminating the requirement for human manipulation inside the greenhouse, and the conveyor system will allow for movement of plants within the greenhouse, resulting in more uniform maturation rates of all plants disposed therein due to uniform exposure to light, temperature and environmental conditions. Further, the conveyor system will allow for automation of other steps in the process of producing a desired plant product which occur outside of the low profile commercial greenhouse, such as pot filling, planting, grading, packaging and shipping.

As an alternative, the low profile commercial greenhouse may itself be moved from position to position to provide more uniform growing conditions as well as to provide other advantages that are typically obtained through the use of a conveyor system. In addition, a low profile commercial greenhouse that is not equipped with a conveyor and that remains stationary also falls within the scope of the present invention.

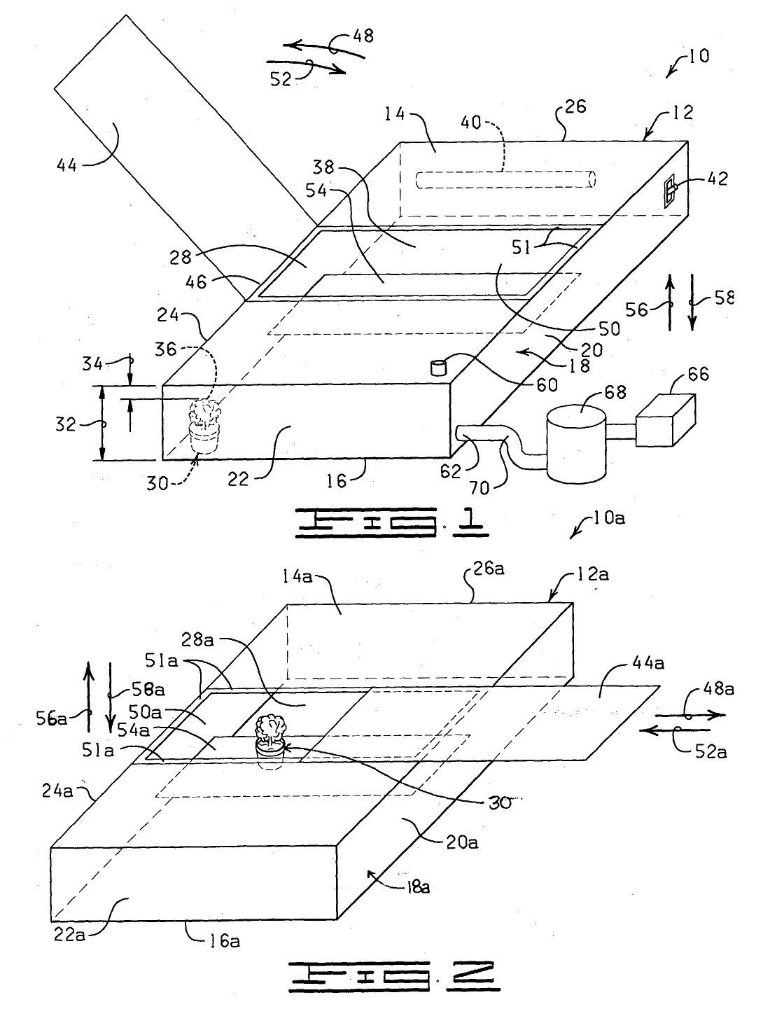

### Embodiments of FIGS. 1 and 2

Referring now to the drawings, shown in FIG. 1 and designated therein by the general reference numeral 10 is one embodiment of a low profile commercial greenhouse constructed in accordance with the present invention. The term “commercial greenhouse” as used herein will be understood to mean a housing in which the temperature and humidity can be regulated for the cultivation of plants for sale. The low profile commercial greenhouse 10 is provided with a housing 12 having an upper end 14, a lower end 16, and a sidewall 18 extending between the upper end 14 and the lower end 16 of the housing 12 and connected to both the upper end 14 and the lower end 16 of the housing 12. The sidewall 18 of the housing 12 is comprised of a first side 20, a second side 22, a third side 24 and a fourth side 26. The upper end 14, the lower end 16 and the sides 20, 22, 24 and 26 of the sidewall 18 cooperate to define a plant retaining space 28 adapted to receive growing plants 30.

While the low profile commercial greenhouse 10 will be described herein for growing plants, it is to be understood that any botanical item, propagule, vegetable, flower, herb, mushroom, culture or any other desired living organism may be grown in the low profile commercial greenhouse 10. Therefore, the terms “plant” or “plants” as used herein will be understood to include one or more botanical items, propagules, vegetables, flowers, herbs, mushrooms, cultures (such as bacterial or fungal cultures) or other living organisms, and combinations thereof.

The plant retaining space 28 has a height 32 so that a sufficient amount of spatial clearance 34 is provided between the upper end 14 of the housing and an upper end 36 of plants 30 growing therein to permit circulation of air and other fluids about the contents of the plant retaining space 28. The height 32 of the plant retaining space 28 of the housing 12 can vary widely as long as the sufficient amount of spatial clearance 34 is provided. Generally, however, the height 32 of the plant retaining space 28 is in a range of from about two feet to about four feet. The height of the low profile commercial greenhouse 10 may be substantially the same as the height 32 of the plant retaining space 28 of the housing 12, or the height of the low profile commercial greenhouse 10 may be more than the height 32 of the plant retaining space 28, depending on the thickness of the materials from which the upper end 14 and the lower end 16 of the housing 12 are constructed, the only requirement being that the height 34 of the plant retaining space 28 be sufficient to permit air and other fluids to circulate about the contents disposed in the plant retaining space 28.

The lower end 16 of the housing 12 can be open when the low profile commercial greenhouse 10 is disposed upon the ground or other flat surface, whereby the ground or other surface serves as a base for the housing 12. However, in the embodiment shown in the drawings, the lower end 16 of the housing 12 is provided with a base or bottom 38 such that the lower end 16 of the housing 12 is closed.

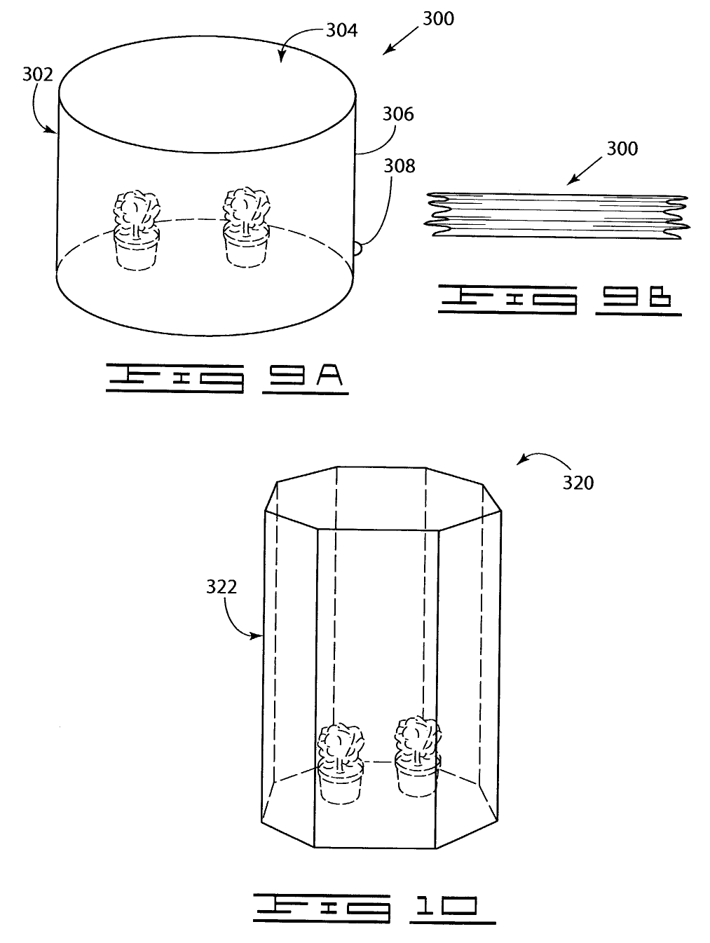

The configuration and shape of the housing 12 of the low profile commercial greenhouse 10 may vary widely, and a rectangular shape is shown in FIG. 1 only by way of example. However, the low profile commercial greenhouse 10 may have any desired configuration, such as square, triangular, cylindrical, polygonal, hexagonal, octagonal, or any other configuration which will sustain the elements of the low profile commercial greenhouse 10 as described herein and permit growth of plants 30 disposed therein, as will be described in more detail herein after with reference to FIGS. 9-11. A low profile commercial greenhouse constructed in accordance with the present invention may be provided with a tubular or oval shape. A tubular or oval-shaped low profile commercial greenhouse could easily be fabricated without the need for structural members, and thus a low profile commercial greenhouse constructed in accordance with the present invention may be provided with a frameless housing.

The low profile commercial greenhouse 10 may be constructed of any material suitable for providing the plant retaining space 28 in which plants 30 can be maintained. For example, the low profile commercial greenhouse 10 may be constructed of glass, plexiglass, plastic, wood, quartz, air streams, electron flows or other energy curtains, or any other similar material which may fully or partially encompass the plant retaining space 28 and provide shelter for the contents of the low profile commercial greenhouse 10.

The low profile commercial greenhouse of the present invention may be formed of an inflatable material which, upon inflation, assumes a cylindrical or tubular or polygonal shape. A plant retaining space of such an inflatable low profile commercial greenhouse may be pressurized or unpressurized. In addition, the inflatable low profile commercial greenhouse may be inflated and/or pressurized with any gas or liquid member known to a person having ordinary skill in the art.

The low profile commercial greenhouse 10 may be constructed of a transparent material which is light-transmitting, while other portions of the low profile commercial greenhouse 10 may be constructed of non-light transmitting materials. For example, the upper end 14 of the housing 12 of the low profile commercial greenhouse 10 may be constructed of a material which is light-transmitting, such as glass, plexiglass or plastic. The entire housing 12 of the low profile commercial greenhouse 10 may be constructed of the same light-transmitting material, and therefore the sidewall 18 and the lower end 16 of the housing 12 may also be light-transmitting. Alternatively, the sidewall 18 and/or the base 38 (if provided) of the housing 12 may be constructed of a different material than the light-transmitting material from which the upper end 14 of the housing 12 is constructed, and the different material may or may not be light-transmitting. For example, the base 38 and the sides 20, 22, 24 and 26 of the sidewall 18 of the housing 12 may be constructed of a material which provides more structural stability than the material from which the upper end 14 of the housing 12 is constructed, and thus provides more resistance to wind damage. Further, the upper end 14 and at least a portion of the sidewall 18 of the housing 12 may be constructed of a light-transmitting material. Alternatively, portions of the upper end 14 of the housing 12 may be constructed of different materials, and a portion of the upper end 14 may be constructed of a material which is light-transmitting while the remaining portion of the upper end 14 may be constructed of a material which provides structural stability to the housing 12 of the low profile commercial greenhouse 10. Alternatively, the sides 20, 22, 24 and 26 of the sidewall 18 may be constructed of different materials, and one or more of the sides 20, 22, 24 and 26 of the sidewall 18 may be constructed of a material which is light-transmitting while the remaining sides 20, 22, 24 and 26 of the sidewall 18 may be constructed of a material which provides structural stability to the housing 12 of the low profile commercial greenhouse 10. In addition, portions of each of the sides 20, 22, 24 and 26 of the sidewall 18 of the housing 12 may be constructed of different materials.

At least a portion of the housing 12 of the low profile commercial greenhouse 10 may be constructed of an opaque material. At times it may be necessary to shade the low profile commercial greenhouse 10, such as to minimize the loss of heat at night. One method of shading the low profile commercial greenhouse 10 would be to pass an electrical current through the glazing of the housing 12 of the low profile commercial greenhouse 10, thereby turning the glazing opaque. Alternatively, at least a portion of the housing 12 of the low profile commercial greenhouse 10 may be made opaque by coating with liquid crystals.

Further, at least a portion of the glazing of the low profile commercial greenhouse 10 may be formed of a glass material or a non-glass material, including but not limited to, polymeric materials and the like.

Any of the constructions of low profile commercial greenhouses 10 described hereinabove may not contain a base 38 and therefore may be provided with an open lower end 16. Alternatively, any of the constructions of low profile commercial greenhouses 10 described hereinbefore may be provided with a base 38 which is constructed of the same or different materials than the upper end 14 and the sides 20, 22, 24 and 26 of the sidewall 18 thereof.

The housing 12 of the low profile commercial greenhouse 10 may also be constructed of materials which are not light-transmitting, and an artificial light source 40 (shown in FIG. 1) may provide artificial lighting in the housing 12. The housing 12 may be provided with a switch 42 on one of the sides 20, 22, 24 and 26 of the sidewall 18 or the upper end 14 of the housing 12 for turning the artificial light source 40 on and off. Plants which require a period of darkness in addition to a period of light exposure can be grown in such a low profile commercial greenhouse 10 which is constructed of non-light-transmitting materials and provided with an artificial light source 40. For example, flowering is photoperiodically induced in the poinsettia, and the plant requires at least 12 hours per day of complete darkness during reflowering season, as very short periods of lighting during this period may be enough to prevent or interfere with flowering. Typically, when these plants are grown in an area which may receive light nightly, even from a street light, the plants are either covered completely at dusk every day with a heavy paper bag, a piece of opaque black cloth or other light-tight cover, or the plants are moved to a dark room. Covering of the plants may result in damage to the leaves of the plant, while moving the plants to a dark room will require a grower of plants to physically move the plants twice a day. Therefore, the use of the non-light-transmitting low profile commercial greenhouse 10 provided with an artificial light source 40 would allow exposure of the plants growing therein to controlled periods of light and darkness, as well as prevent injury to the plants by not requiring the grower to directly interact with the plant. In addition, the low profile commercial greenhouse 10 may be provided with the ability to vary light from natural and/or artificial sources, as well as to vary the intensity of light and spectrum of light from natural and/or artificial sources.

In addition, the low profile commercial greenhouse 10 may be constructed from a material that allows for filtering of light from natural sources. For example, at least a portion of the low profile commercial greenhouse 10 may also be constructed of a material which admits ultraviolet light, such as sheet plastic. Ultraviolet light has been demonstrated to act as a growth regulator in certain plants, and therefore transmission of ultraviolet light into the plant retaining space 28 of the housing 12 of the low profile commercial greenhouse 10 may be desired. The portion of the low profile commercial greenhouse 10 which admits ultraviolet light may be the same as the portion which admits visible light, such as the upper end 14 and/or at least a portion of one or more sides 20, 22, 24 and 26 of the sidewall 18 of the housing 12. For example, glass admits visible light but filters out most ultraviolet light, and materials which admit ultraviolet light but not visible light are known in the art. Therefore, the upper end 14 of the housing 12 may be constructed of a material which transmits only visible light, or the upper end 14 of the housing 12 may be constructed of a material which transmits both visible and ultraviolet light, while at least a portion of one or more sides 20, 22, 24 and 26 of the sidewall 18 of the housing 12 may be constructed of a material which transmits only visible light, only ultraviolet light, both visible light and ultraviolet light, or does not transmit visible or ultraviolet light. Alternatively, a portion of the low profile commercial greenhouse 10 may be constructed of a material which is light-transmitting, and the low profile commercial greenhouse 10 may be provided with the artificial light source 40 which provides ultraviolet light rather than visible light to the plant retaining space 28 of the housing 12. In this manner, the ultraviolet light can be directed specifically at the plants 30 rather than nonspecifically at the entire plant retaining space 28 of the housing 12, which would be beneficial when components constructed of materials which are sensitive to ultraviolet light are present in the plant retaining space 28 of the housing 12, such as hoses and shade screens, thereby preventing UV degradation of such components. In addition, by providing ultraviolet light via the artificial light source 40, the exposure to ultraviolet light can be controlled, and the plant retaining space 28 of the housing 12 can be provided with a minimal exposure to the ultraviolet light.

In a similar manner, the low profile commercial greenhouse 10 may be constructed of a material that is spectrum modulatory. In this manner, the spectrum of light that passes through the material from which the low profile commercial greenhouse 10 is constructed and into the plant retaining space 28 thereof may be bent or changed in some fashion. This may result in the plant retaining space 28 of the low profile commercial greenhouse 10 only receiving certain spectrums of light, such as but not by way of limitation, white light, yellow light, red light, and the like.

At least a portion of the upper end 14 of the housing 12 may be movable independently of the sides 20, 22, 24 and 26 of the sidewall 18 and the lower end 16 of the housing 12. That is, a lid 44 (FIG. 1) is provided in a portion of the upper end 14 of the housing 12 which is hingeably connected to a portion of the side 24 of the sidewall 18 via a hinge element 46. The lid 44 can be moved in a direction indicated by the arrow 48 to provide an opening 50 in the upper end 14 of the housing 12 to provide a grower of plants access to at least a portion of the plant retaining space 28 of the housing 12. Following movement in the direction indicated by the arrow 48, the lid 44 may be closed by moving in a direction indicated by the arrow 52.

The upper end 14 of the housing 12 is also provided with a set of rim or lip elements 51 stationarily attached thereto which outline the areas to which the lid 44 attaches to the upper end 14 of the housing 12 when the lid 44 is in a closed position. The rim or lip elements 51 prevent the lid 44 from falling below the upper end 14 of the housing 12 and into the plant retaining space 28 of the housing 12 when the lid 44 is in the closed position.

The low profile commercial greenhouse 10 may also be provided with a rack 54 disposed in the plant retaining space 28 of the housing 12 upon which plants 30 may be disposed. The rack 54 allows for ease of manipulation of plants 30 contained within the plant retaining space 28 of the housing and facilitates insertion of plants 30 into and removal of plants 30 from the plant retaining space 28 of the housing 12. The rack 54 is removable or retractable in a direction indicated by the arrow 56, as shown in FIG. 1, to dispose the rack 54 adjacent the upper end 14 of the housing 12, making plants 30 disposed thereon more easily accessed than if the plants 30 were simply disposed on the lower end 16 of the housing 12 of the low profile commercial greenhouse 10. Further movement of the rack 54 in the direction indicated by the arrow 56 will allow removal of the rack 54 from the plant retaining space 28 of the housing 12 of the low profile commercial greenhouse 10. When it is desired to dispose plants 30 positioned on the rack 54 within the plant retaining space 28 of the housing 12 of the low profile commercial greenhouse 10, the rack 54 is moved in a direction indicated by the arrow 58 until the rack 54 is disposed upon the lower end 16 of the housing 12, such as the base 38 of the housing 12 if the lower end 16 of the housing 12 is closed or the ground or other flat surface if the lower end 16 of the housing 12 is opened. Alternatively, the rack 54 may be formed of a portion of the base 38 of the housing 12 (not shown).

In one method of use of the low profile commercial greenhouse 10, the lid 44 provided in the upper end 14 of the housing 12 is moved in the direction indicated by the arrow 48 to expose the opening 50, and the rack 54 is lifted in the direction indicated by the arrow 56. The plants 30 are then disposed on the rack 54 and the rack 54 containing the plants 30 is disposed in the plant retaining space 28 of the housing 12 by moving the rack 54 in the direction indicated by the arrow 58, and the lid 44 is then closed by moving the lid 44 in the direction indicated by the arrow 52. When it is desired to manipulate the plants 30 or remove the plants 30 from the low profile commercial greenhouse 10, the lid 44 is opened as previously described herein, and the rack 54 is moved in the direction 56 to dispose the rack 54 adjacent the upper end 14 of the housing 12 or remove the rack 54 from the housing 12, and thereby permit removal of the plants 30 from the rack 54 and thus from the plant retaining space 28 of the housing 12 of the low profile commercial greenhouse 10.

It will be understood that the low profile commercial greenhouse 10 may not be provided with the rack 54 therein, and upon moving the lid 44 in the direction indicated by the arrow 48, plants 30 are directly disposed on the lower end 16 of the housing 12 and within the plant retaining space 28 of the housing 12 of the low profile commercial greenhouse 10.

The upper end 14 of the housing 12 of the low profile commercial greenhouse 10 may be provided with at least one aperture or port 60, and at least one of the sides 20, 22, 24 and 26 of the sidewall 18 of the housing 12 may also be provided with at least one aperture or port, such as the aperture 62 in the first side 20 of the sidewall 18 of the housing 12 shown in FIG. 1. The terms “aperture” and “port” may be used interchangeably herein and will be understood to mean any opening, hole or gap, such as in a cylinder face or valve face, which allows for the passage of steam, gas, liquid, etc., into or out of the plant retaining space 28 of the housing 12 of the low profile commercial greenhouse 10.

An atmosphere is provided within the plant retaining space 28 of the housing 12, and the atmosphere may be modified via the apertures 60 and/or 62 when the low profile commercial greenhouse 10 is closed, that is, when the lid 44 provided in the upper end 14 of the housing 12 is in a closed position, and therefore a grower of plants does not have access to the plant retaining space 28 via the opening 50 in the upper end 14 of the housing 12. When the low profile greenhouse 10 is closed, the atmosphere surrounds the plants 30 disposed in the plant retaining space 28 of the housing 12 of the low profile commercial greenhouse 10. The housing 12 may be substantially gas permeable and/or liquid permeable, or the housing 12 may be sealed such that the housing 12 is substantially gas impermeable and/or substantially liquid impermeable. Modifications to the atmosphere will be substantially more effective when the housing 12 is gas and liquid impermeable. The atmosphere can be modified when the housing 12 is gas permeable, but diffusion of the modification will occur until an equilibrium is reached with the atmosphere immediately surrounding the low profile commercial greenhouse 10. The modification to the atmosphere may include, but is not limited to, injecting a disinfectant, such as a pesticide, herbicide or fungicide; injecting a growth regulator or one or more nutrients; injecting water and/or varying humidity; varying temperature; varying light, including varying light source, light intensity and light spectrum; exhausting the atmosphere, such as to remove chemicals; varying oxygen, carbon dioxide, nitrogen and/or other gas concentrations; varying the carbon dioxide concentration; extracting an atmospheric sample to determine what modifications to the atmosphere need to be made; and combinations thereof.

The present invention includes a method of using a low profile commercial greenhouse to improve and facilitate natural pest and disease control methods, such as but not limited to, controlled humidity levels, and/or zones of low humidity, light which destroys or inhibits growth of pests and disease-causing organisms and/or enhances plant health and resistance to diseases, and/or screening of entrances and access areas to greenhouses to prevent entry of pests and disease-causing organisms, and/or filtration of air to trap and eliminate pests and disease-causing organisms and/or the use of air streams and/or vacuums to remove pests and disease-causing organisms from the plants and greenhouses.

The term “disinfectant” as used herein will be understood to include agents possessing antifungal properties, antibacterial (bacteriostatic or bactericidal) properties, insecticidal properties, and/or antimicrobial properties. It will also be understood that many disinfectants are known in the art. It will further be appreciated that the precise combinations and amounts of disinfectants used is dependent upon the results sought and the type of plants to be grown. The duration of action of the disinfectant(s) will depend, in part, upon the disinfectant(s) used, the concentration of the disinfectant(s) used, and the exposure of the disinfectant(s) to atmospheric conditions.

The term “growth regulator” as used herein will be understood to include agents possessing growth, maturation and/or bloom stimulating properties, growth, maturation and/or bloom inhibiting properties, and growth, maturation and/or bloom retarding properties. It will also be understood that many growth regulators are known in the art. It will further be appreciated that the precise combinations and amounts of growth regulators used is dependent upon the results sought and the type of plants to be grown. The duration of action of the growth regulator(s) will depend, in part, upon the growth regulator(s) used, the concentration of the growth regulator(s) used, and the exposure of the growth regulator(s) to atmospheric conditions.

It has been demonstrated that lowered oxygen levels and/or increased carbon dioxide levels have several desirable effects on growing plants, including

pest control, disease control and regulation of growth rates. Therefore, it may be desirable to decrease the oxygen level or increase the carbon dioxide level of the atmosphere provided in the plant retaining space 28 of the housing 12 when the housing 12 is sealed, thereby rendering the housing 12 substantially gas impermeable. Decreasing the oxygen level and/or increasing the carbon dioxide level may be accomplished by injecting gases directly into the plant retaining space 28 of the housing 12 via the apertures 60 and/or 62, by first exhausting the plant retaining space 28 of the housing 12 and then injecting the desired atmosphere, or by inserting scrubber compounds therein. The term “scrubber compound” as used herein will be understood to include compounds which selectively absorb certain gases from the surrounding atmosphere, thereby lowering the concentration of a specific component of such atmosphere. For example, a carbon dioxide scrubber will absorb carbon dioxide gas from the surrounding atmosphere and decrease the concentration of carbon dioxide in such atmosphere. Scrubber compounds and the use thereof for controlling levels of gaseous compounds in an enclosed atmosphere are well known in the art. Examples of carbon dioxide scrubbers include sodium hydroxide, water, activated charcoal, hydrated lime, a molecular sieve and combinations thereof.

The modification of injecting water may require a single aperture 60 and/or 62, resulting in a spray or stream of water, or may require multiple apertures 60 and/or 62, resulting in a sprinkler system. The modification of varying humidity may include injecting water or water-saturated air to increase humidity, or injecting a desiccant to decrease humidity. The modification of varying temperature may involve the injection of warmed or cooled air to obtain a desired temperature within the atmosphere of the plant retaining space 28 of the housing 12. The modification of exhausting the atmosphere, such as to remove chemicals, may involve simply opening the aperture(s) 60 and/or 62 to allow diffusion of the chemicals to the atmosphere surrounding the low profile commercial greenhouse 10, or may include attaching a vacuum to the aperture 60 or 62, such as the vacuum 66 attached to the aperture 62 in FIG. 1, to withdraw the atmosphere containing the unwanted chemicals from the plant retaining space 28 of the housing 12. A collection device 68 may be attached to one of the apertures 60 and 62 and the vacuum 66, such as the collection device 68 attached to the aperture 62 and the vacuum 66 as shown in FIG. 1, to prevent release of the unwanted chemicals into the atmosphere surrounding the low profile commercial greenhouse 10. The collection of the chemicals prevents release of toxic substances into the environment and also allows for disposal of the chemicals in a more environmentally-friendly manner. In addition, exhaustion of the plant retaining space 28 of the housing 12 may be performed before a modified atmosphere containing desired oxygen and carbon dioxide concentrations is injected into the plant retaining space 28 of the housing 12, as described above.

The aperture(s) 60 and/or 62 may also be used to extract a sample of the atmosphere provided in the plant retaining space 28 of the housing 12 so that atmospheric variables, such as temperature, humidity, oxygen and carbon dioxide levels, ethylene levels (as ethylene can be injurious to plants), and chemical and chemical byproduct levels, can be detected or determined.

It will also be understood that the apertures 60 and/or 62 may be large enough so as to provide ventilation to the plant retaining space 28 of the housing 12 of the low profile commercial greenhouse 10, thereby providing a gas permeable housing 12. The apertures 60 and/or 62 may be plugged to prevent ventilation if so desired. Alternatively, the apertures 60 and/or 62 may be ports which are sealed under normal conditions and substantially gas impermeable until opened or unsealed for injection into or extraction from the plant retaining space 28 of the housing 12. In this case, the apertures 60 and/or 62 may be provided with a switching element (not shown) which opens and closes the apertures 60 and/or 62. In this manner, the apertures 60 and/or 62 would allow for evacuation of the plant retaining space 28 of the housing 12 as well as maintaining ambient conditions in the plant retaining space 28 of the housing 12. Alternatively, tubing may be attached to the apertures or ports 60 and/or 62 before opening the apertures or ports 60 and/or 62 so that injection or extraction through the aperture or port 60 and/or 62 may be controlled. For example, a hose 70 is attached to the collection device 68 and the aperture 62 in FIG. 1 so that when the aperture 62 is opened, the atmosphere diffusing from the plant retaining space 28 of the housing 12 will flow into the hose 70 to the collection device 68, and the vacuum 66 may assist in the diffusion process. Flow of a substance such as water or gas into the plant retaining space 28 via the apertures 60 and/or 62 can be controlled in a similar manner. In this way, diffusion of the atmosphere contained in the plant retaining space 28 of the housing 12 into the atmosphere surrounding the low profile commercial greenhouse 10, as well as diffusion of the atmosphere surrounding the low profile commercial greenhouse into the atmosphere contained within the plant retaining space 28 of the housing 12, will be effectively eliminated, and the components of the atmosphere contained within the plant retaining space 28 of the low profile commercial greenhouse 10 can be strictly controlled.

Shown in FIG. 2 is another embodiment of a low profile commercial greenhouse designated by the reference numeral 10a, which is similar to the low profile commercial greenhouse 10 shown in FIG. 1 and described in detail hereinabove, except as described hereinbelow. A portion of an upper end 14a of a housing 12a of the low profile commercial greenhouse 10a forms a lid 44a similar to the lid 44 of the low profile commercial greenhouse 10 shown in FIG. 1 and described hereinbefore, except that the lid 44a is not connected to sides 20a, 22a, 24a or 26a of a sidewall 18a. The upper end 14a of the housing 12a is provided with a set of rim or lip elements 51a which prevent the lid 44a from falling below the upper end 14a and into the plant retaining space 28a of the housing 12a. The set of rim or lip elements 51a may be slats for permitting slidable movement of the lid 44a in relation to the sides 20a, 22a, 24a and 26a of the sidewall 18a of the housing 12a of the low profile commercial greenhouse 10a. In this manner, the lid 44a can be moved in a direction indicated by the arrow 48a to expose an opening 50a in the upper end 14a thereof to provide a grower of plants access to at least a portion of the plant retaining space 28a of the housing 12a. The opening 50a can be closed by moving the lid 44a in a direction indicated by the arrow 52a.

The low profile commercial greenhouse 10a may also be provided with a rack 54a disposed in the plant retaining space 28a of the housing 12a. The rack 54a is constructed similar to and used in the same manner as the rack 54 of the low profile commercial greenhouse 10 shown in FIG. 1 and described in detail hereinbefore.

In a method of use of the low profile commercial greenhouse 10a, the lid 44a is moved in the direction indicated by the arrow 48a to expose the opening 50a, and the rack 54a is lifted in a direction indicated by the arrow 56a. Plants 30 can then be disposed on the rack 54a, and the rack 54a with the plants 30 disposed thereon is disposed in the plant retaining space 28a of the housing 12a by moving the rack 54a in a direction indicated by the arrow 58a. Once the rack 54a having the plants 30 disposed thereon is disposed in the plant retaining space 28a of the housing 12a, the lid 44a is closed by moving in the direction indicated by the arrow 52a. When it is desired to manipulate plants 30 or remove plants 30 from the low profile commercial greenhouse 10a, the lid 44a is opened as previously described herein, and the rack 54a is moved in the direction 56a to dispose the rack 54a adjacent the upper end 14a of the housing 12a or to remove the rack 54a from the housing 12a, and therefore remove plants 30 disposed thereon from the housing 12a of the low profile commercial greenhouse 10a.

It will be understood that the low profile commercial greenhouse 10a may not be provided with a rack 54a, and plants 30 can be directly disposed on the lower end 16a of the housing 12a and within the plant retaining space 28a of the housing 12a.

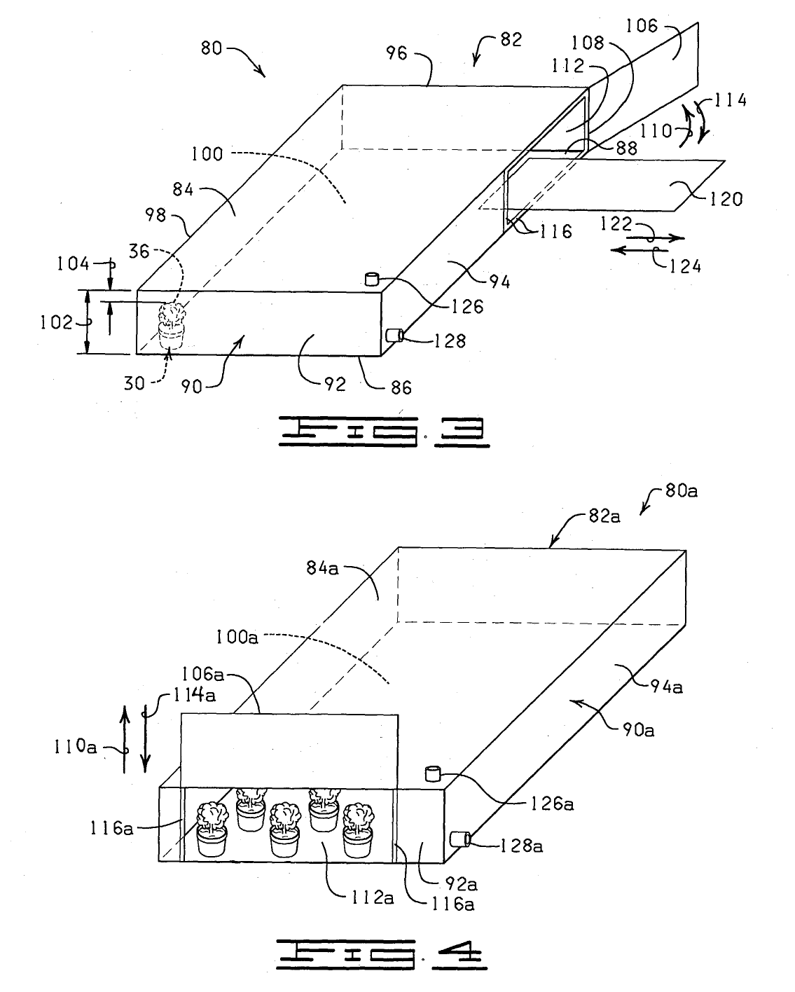

### Embodiments of FIGS. 3 and 4

Shown in FIG. 3 is another embodiment of a low profile commercial greenhouse designated by the reference numeral 80, which is constructed and utilized in a similar manner to the low profile commercial greenhouses 10 and 10a described hereinabove and depicted in FIGS. 1 and 2, except as described hereinbelow.

The low profile commercial greenhouse 80 is provided with a housing 82 having an upper end 84, a lower end 86 which may be open or closed, and when the lower end 86 is closed a base 88 is formed, and a sidewall 90. The sidewall 90 of the housing 82 comprises a first side 92, a second side 94, a third side 96 and a fourth side 98. The upper and lower ends 84 and 86 and the sides 92, 94, 96 and 98 of the sidewall 90 cooperate to define a plant retaining space 100 in the housing 82 which is adapted to receive growing plants 30. The plant retaining space 100 is provided with a height 102 which provides a sufficient amount of spatial clearance 104 between the upper end 84 of the housing 82 and the upper end 36 of plants 30 disposed therein.

One of the sides of the sidewall 90 of the housing 82, such as the second side 94, is provided with at least a portion which is movable independently of the other remaining sides of the sidewall 90 (i.e., sides 92, 96 and 98) and the upper and lower ends 84 and 86 of the housing 82. That is, a portion of the second side 94 of the sidewall 90 (FIG. 3) forms a door 106 which is hingeably connected to an adjacent portion of a side, such as the third side 96 (FIG. 3), via a hinge element 108. The door 106 can be moved in a direction indicated by the arrow 110 to provide an opening 112 in the second side 94 of the sidewall 90 to provide a grower of plants access to at least a portion of the plant retaining space 100 of the housing 82 of the low profile commercial greenhouse 80. Following movement in the direction indicated by the arrow 110, the door 106 may be closed by moving in a direction indicated by the arrow 114.

The second side 94 of the sidewall from which a portion forms the door 106 may also be provided with a set of rim or lip elements 116 stationarily attached to the second side 94 of the sidewall 90 as shown in FIG. 3, and which outline the areas to which the door 106 is disposed adjacent to the second side 94 of the sidewall 90 when the door 106 is in a closed position. The set of rim or lip elements 116 temporarily secure the door 106 in a closed position and prevent the door 106 from swinging into the plant retaining space 100 of the housing 82 of the low profile commercial greenhouse 80.

The low profile commercial greenhouse 80 may also be provided with a rack 120 disposed in the plant retaining space 100 of the housing 82 upon which plants 30 may be disposed. The rack 120 is similar to the rack 54 provided in the low profile commercial greenhouse 10 shown in FIG. 1 and described in detail hereinbefore, except that the rack 120 is moved in and out of the plant retaining space 100 of the housing 82 in a horizontal direction rather than a vertical direction. Thus, the rack 120 may be moved in a direction indicated by the arrow 122 to remove the rack 120 from the plant retaining space 100 of the housing 82, and the rack 120 may be disposed in the plant retaining space 100 of the housing 82 by moving the rack 120 in a direction indicated by the arrow 124.

Alternatively, the low profile commercial greenhouse 80 may not be provided with a rack 120, and plants 30 can be directly disposed through the door 106 and are positioned on the lower end 86 of the housing 82 within the plant retaining space 100 of the housing 82 of the low profile commercial greenhouse 80.

The low profile commercial greenhouse 80 may also be provided with an artificial light source (not shown) similar to the artificial light source 40 described in detail hereinbefore with reference to the low profile commercial greenhouse 10 of FIG. 1.

The low profile commercial greenhouse 80 may also be provided with at least one aperture or port 126 in the upper end 84 of the housing 82. At least one of the sides of the sidewall 90, such as the second side 94 of the sidewall 90, may also be provided with at least one aperture or port, such as the aperture or port 128 as shown in FIG. 3. The apertures 126 and 128 are similar to the apertures 60 and 62 of the low profile commercial greenhouse 10 hereinbefore described with reference to FIG. 1, and the atmosphere provided in the plant retaining space 100 of the housing 82 of the low profile commercial greenhouse 80 may be modified via the apertures 126 and 128 in a similar manner as that described hereinbefore for modifying the atmosphere contained within the plant retaining space 28 of the housing 12 of the low profile commercial greenhouse 10.

Shown in FIG. 4 is another embodiment of a low profile commercial greenhouse designated by the reference numeral 80a which is similar to the low profile commercial greenhouse 80 shown in FIG. 3 and described in detail before, except that the low profile commercial greenhouse 80a is provided with a door 106a in a side of a sidewall 90a of a housing 82a of the low profile commercial greenhouse 80a, such as a side 92a as shown in FIG. 4. The door 106a is provided with a set of rim or lip elements 116a which are slats which permit slidable movement of the door 106a in relation to the sidewall 90a of the housing 82a, as opposed to the hingeably connected door 106 of the low profile commercial greenhouse 80 shown in FIG. 3 and described in detail above. The door 106a can be opened by slidably moving the door 106a in a direction indicated by the arrow 110a, thereby exposing an opening 112a in the side 92a of the sidewall 90a of the housing 82a which provides a grower of plants access to at least a portion of a plant retaining space 100a contained within the housing 82a of the low profile commercial greenhouse 80a. The door 106a may be closed by slidably moving the door 106a in a direction indicated by the arrow 114a.

The low profile commercial greenhouse 80a may be provided with a rack (not shown) substantially similar to the rack 120 disposed within the low profile commercial greenhouse 80 shown in FIG. 3 and described in detail hereinbefore, as well as an aperture 126a provided in an upper end 84a of the housing 82a and an aperture 128a provided in at least one of the sides of the sidewall 90a, such as a side 94a, of the housing 82a. The apertures 126a and 128a are substantially similar to the apertures 126 and 128 hereinbefore described with reference to the low profile commercial greenhouse 80 of FIG. 3.

It will be understood that each of the low profile commercial greenhouses 80 and 80a may be sealed such that the housing 82-82a is gas impermeable when the door 106-106a is in the closed position. Once the plants 30 are disposed in the plant retaining space 100-100a of the low profile commercial greenhouse 80-80a, the door 106-106a of the low profile commercial greenhouse 80-80a remains closed and the grower of plants only manipulates the plants 30 and/or the atmosphere disposed within the plant retaining space 100-100a through the apertures 126-126a and/or 128-128a. Alternatively, the housing 82-82a of the low profile commercial greenhouse 8080a may be gas permeable, and the plants 30 disposed in the plant retaining space 100-100a of the housing 82-82a may be manipulated during growth via the apertures 126-126a and 128-128a and the door 106-106a of the low profile commercial greenhouse 80-80a.

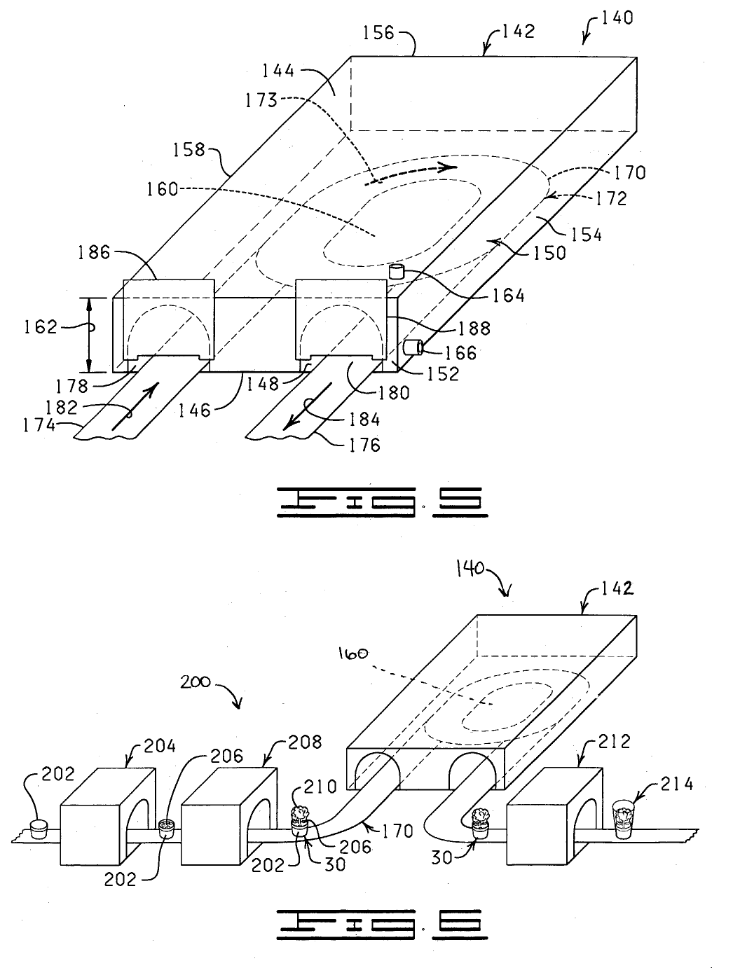

### Embodiments of FIGS. 5 and 6

Shown in FIG. 5 is another embodiment of a low profile commercial greenhouse designated by the reference numeral 140, which is similar to the low profile commercial greenhouses 10-10a and 80-80a hereinbefore described and shown in FIGS. 1-4, except as described hereinbelow. The low profile commercial greenhouse 140 is provided with a housing 142 having an upper end 144 and a lower end 146 which is closed, thereby forming a base 148. The housing 142 also includes a sidewall 150 which comprises a first side 152, a second side 154, a third side 156 and a fourth side 158. The upper and lower ends 144 and 146 and the sides 152, 154, 156 and 158 of the sidewall 150 cooperate to define a plant retaining space 160 adapted to receive growing plants, such as the plants 30 shown in FIGS. 1-4, and the plant retaining space 160 is provided with a height 162 which provides a sufficient amount of spatial clearance between the upper end 144 of the housing 142 and the upper end of plants (such as the upper end 36 of plants 30 shown in FIGS. 1-4) disposed therein. The low profile commercial greenhouse 140 is also shown as having at least one aperture or port 164 in the upper end 144 of the housing 142, and at least one or more apertures or ports 166 in one of the sides of the sidewall 150 of the housing 142, such as the sidewall 154 (FIG. 5). The apertures 164 and 166 are substantially similar to the apertures 60 and 62 hereinbefore described with reference to the low profile commercial greenhouse 10 of FIG. 1, and may be utilized to modify the atmosphere of the plant retaining space 160 of the housing 142 of the low profile commercial greenhouse 140 in a similar manner.

The low profile commercial greenhouse 140 is further provided with a conveyor system 170 disposed in the plant retaining space 160 of the housing 142. The conveyor system 170 conveys plants (such as the plants 30 of FIGS. 1-4) to a desired position in the plant retaining space 160 of the low profile commercial greenhouse 140. As not all areas of the low profile commercial greenhouse 140 will receive the same amount of sunlight, the ability to rotate the plants disposed therein will produce a more uniform exposure of each plant to sunlight, thereby allowing the plants to mature at a uniform rate. In the same manner, the rotation of plants by the conveyor system 170 will also allow for uniform exposure of the plants to modifications to the atmosphere provided by the aperture(s) 164 and/or 166, such as water or disinfectants.

The conveyor system 170 comprises a first conveyor 172 which travels along a predetermined path in the plant retaining space 160 of the housing 142. The path of travel of the first conveyor 172 may be of any configuration which sustains stable movement of the plants within the plant retaining space 160 of the housing 142. The path of travel of the first conveyor 172 depicted in FIG. 5 is shown as a circular or oval configuration only by way of example. The first conveyor 172 may rotate in a clockwise or counterclockwise direction, and a counter-clockwise direction is indicated by the arrow 173 only by way of example.

The conveyor system 170 may also be provided with a second conveyor 174 and a third conveyor 176 which are connected to the first conveyor 172 and which extend through openings 178 and 180, respectively, in the first side 152 of the sidewall 150 of the housing 142. The openings 178 and 180 are shown extending through the first side 152 of the sidewall 150 of the housing 142 by way of example only, and it will be understood that the openings 178 and 180 may be provided in any of the sides of the sidewall 150 of the housing 142, and that the openings 178 and 180 may be provided in different sides of the sidewall 150 of the housing 142.

As shown by way of example in FIG. 5, the second conveyor 174 travels in a direction indicated by the arrow 182 which enters the housing 142 through the opening 178, and plants disposed on the second conveyor 174 outside of the housing 142 are transported through the opening 178 into the plant retaining space 160 of the housing 142 via the second conveyor 174 rotating in the direction 182. A switching element (not shown) is provided which changes the connection of the first conveyor 172 from connecting to itself to connecting to the second conveyor 174 so that plants being transported on the second conveyor 174 are transferred to the first conveyor 172. The switching element then changes the track of the first conveyor 172 to once again connect with itself so that the plants are rotatably transported around the plant retaining space 160 of the housing 142 as described hereinbefore. When it is desired to remove the plants from the housing 142 of the low profile commercial greenhouse 140, a second switching element (not shown) is provided which changes the track of the first conveyor 172 from connecting to itself to connecting to the third conveyor 176, which travels in a direction indicated by the arrow 184 which exits the housing 142 through the opening 180, and plants disposed on the third conveyor 176 in the plant retaining space 160 of the housing 142 are transported through the opening 180 and out of the housing 142 of the low profile commercial greenhouse 140 via the third conveyor 176 rotating in the direction 184.

It will also be understood that the conveyor system 170 may also be provided with the first conveyor 172 and only the second conveyor 174 or the third conveyor 176 such that only entry or exit from the housing 142 is performed by the conveyor system 170. In a further embodiment, only one of the second or third conveyors 174 or 176 is provided, and the second or third conveyor 174 or 176 is provided with a switching element (not shown) which changes the direction of rotation of the second or third conveyor 174 or 176, thereby allowing entry and exit of plants from the housing 142 via a single conveyor, i.e., the second or third conveyor 174 or 176.

The openings 178 and 180 in the first side 152 of the sidewall 150 of the housing 142 may be sealable such that the housing 142 is gas impermeable when the openings 178 and 180 are sealed. For example as shown in FIG. 5, side 152 is provided with a door 186 which covers the opening 178 and a door 188 which covers the opening 180 when it is desired to seal the housing 142. Alternatively, the openings 178 and 180 may remain partially open to allow air flow through the housing 142 such that the housing 142 is gas permeable.

Now it will be understood that any of the low profile commercial greenhouses 10-10a and 80-80a described herein may be provided with a conveyor system 170 which comprises the conveyors 172, 174 and 176, or a conveyor system which consists only of the first conveyor 172. When the low profile commercial greenhouse 10-10a is provided with the conveyor system 170 which comprises only the first conveyor 172 (not shown), disposal and removal of plants 30 from the plant retaining space 28-28a of the housing 12-12a is performed through the lid 44-44a in the upper end 14-14a of the housing 12-12a. When the low profile commercial greenhouse 80-80a is provided with the conveyor system 170 which comprises only the first conveyor 172 (not shown), disposal and removal of plants 30 from the plant retaining space 100-100a of the housing 82-82a is performed through the door 106-106a in one of the sides 92-92a, 94-94a, 96-96a or 98-98a of the sidewall 90-90a of the housing 82-82a. When any of the low profile commercial greenhouses 10-10a or 80-80a are provided with the conveyor system 170 containing the first conveyor 172 and at least one of the conveyors 174 or 176 (not shown), plants 30 may be conveyed into or removed from the plant retaining space 28-28a or 100-100a of the housing 12-12a or 82-82a via one or both of the conveyors 174 or 176, and the lid 44-44a or the door 106-106a may be utilized to maintain the plants 30 rather than to dispose or remove the plants 30, or the plants 30 may be either conveyed into or out of the plant retaining space 2828a or 100-100a of the housing 12-12a or 82-82a via one of the conveyors 174 or 176 which is provided, and the lid 44-44a or the door 106-106a utilized for the function not performed by the second conveyor 174 or 176 provided.

Another advantage of the low profile commercial greenhouse as described herein is the ease of automation of plant growth and maturation with other steps in the process of producing a desired plant product. For example, the low profile commercial greenhouse 140 as described herein can be combined with other elements involved in producing a desired plant product which occur outside of the low profile commercial greenhouse 140, such as pot filling, planting, and packaging.

Shown in FIG. 6 is an example of an automated system 200 for growing plants and preparing plants for distribution and sale comprising the low profile commercial greenhouse 140 shown in FIG. 5 and described hereinbefore connected to additional elements involved in the process of growing plants and preparing plants for distribution and sale. The conveyor system 170 extends through the low profile commercial greenhouse 140 and the additional elements, resulting in the automated system 200. A flower pot 202 is disposed on the conveyor system 170 which first passes through a pot filling system 204 that disposes growing medium 206 in the flower pot 202. Next, the conveyor system 170 conveys the flower pot 202 containing growing medium 206 through a planting system 208 which disposes a floral grouping, plant, flower, botanical item, and/or propagule 210 in the growing medium 206 disposed in the flower pot 202. The term “plant 30” as used herein previously refers to the flower pot 202 having growing medium 206 and a floral grouping, plant, flower, botanical item, and/or propagule 210 disposed therein.

The term “floral grouping” may be used interchangeably herein with the terms “plant” and/or “flower”. The term “floral grouping” may also be used interchangeably herein with the terms “botanical item” and/or “propagule”. The term “botanical item” when used herein means a natural herbaceous or woody plant, taken singly or in combination. The term “botanical item” also means any portion or portions of natural herbaceous or woody plants including stems, leaves, flowers, blossoms, buds, blooms, cones, or roots, taken singly or in combination, or in groupings of such portions such as a bouquet or floral grouping.

The term “propagule” when used herein means any structure capable of being propagated or acting as an agent of reproduction including seeds, shoots, stems, runners, tubers, plants, leaves, roots or spores.

Following pot filling and planting, the plant 30 is conveyed into the plant retaining space 160 of the housing 142 of the low profile commercial greenhouse 140 and allowed to grow and mature therein. Once the plant 30 has grown and matured to the desired state, the plant 30 is removed from the low profile commercial greenhouse 140 via the conveyor system 170 and conveyed to a packaging system 212. The packaging system 212 packages the plant 30 by any method and apparatus known in the art, including but not by way of limitation, disposing a sleeve about the plant 30 to form a decorative cover 214, as shown in FIG. 6, wrapping a sheet of material about the plant 30 to form a decorative cover, and inserting the plant 30 in a preformed decorative cover. Methods and apparatus for forming a sleeve and inserting such sleeve about a plant to form a decorative cover are disclosed in U.S. Pat. No. 5,625,979 entitled “SLEEVE HAVING A DETACHABLE PORTION FORMING A SKIRT AND METHODS”, issued to Weder on May 6, 1997, which is hereby expressly incorporated herein by reference. Methods and apparatus for automatically securing a sheet of material about a plant to form a decorative cover are disclosed in U.S. Pat. No. 5,105,599 entitled “MEANS FOR SECURING A DECORATIVE COVER ABOUT A FLOWER POT” issued to Weder on Apr. 21, 1992, U.S. Pat. No. 4,733,521 entitled “COVER FORMING APPARATUS”, issued to Weder et al on Mar. 29, 1988, and U.S. Pat. No. 5,291,721 entitled “COVER FORMING APPARATUS HAVING PIVOTING FORMING MEMBERS”, issued to Weder et al on Mar. 8, 1994, all of which are hereby expressly incorporated herein by reference. Methods and apparatus for forming preformed decorative covers are disclosed in U.S. Pat. No. 4,773,182 entitled “ARTICLE FORMING SYSTEM” issued to Weder et al on Sep. 27, 1998, which is hereby expressly incorporated herein by reference, and U.S. Pat. No. 5,291,721 as described above.

It will be understood that not all of the automated steps shown in FIG. 6 may be required, and other steps involved in growing plants and preparing plants for distribution and sale which are known to a person of ordinary skill in the art may be utilized in the automated system as envisioned by the present invention.

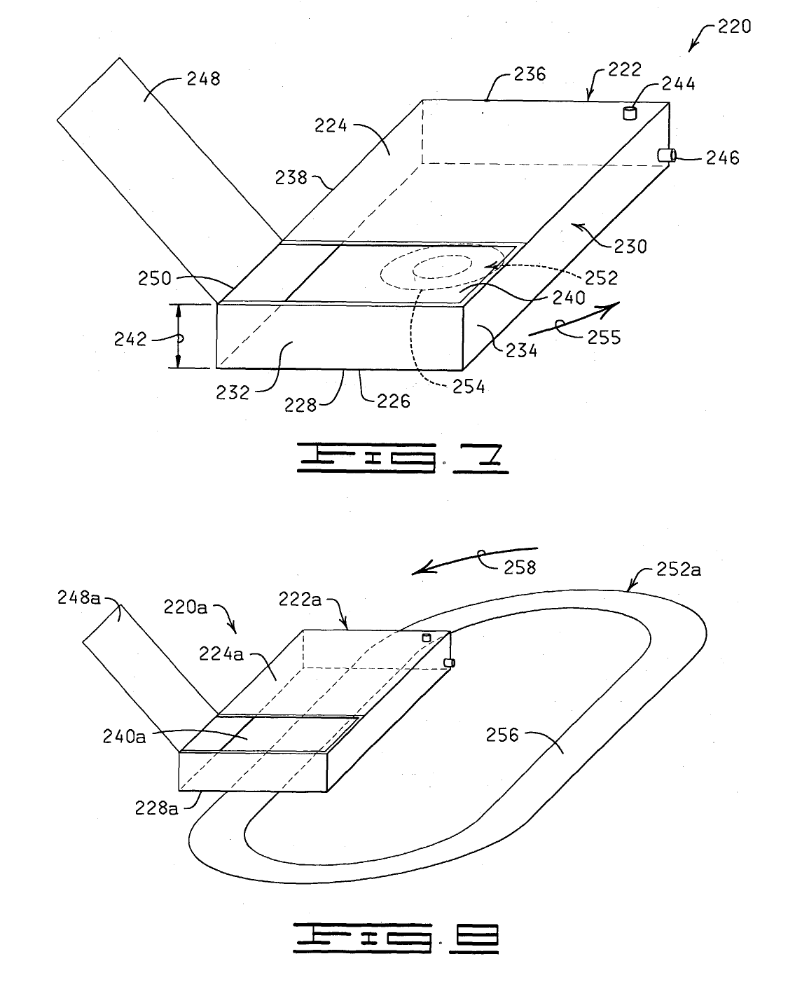

### Embodiments of FIGS. 7 and 8

Shown in FIG. 7 is yet a further embodiment of the low profile commercial greenhouse, designated by the reference numeral 220, which is similar to the low profile commercial greenhouses 10-10a, 80-80a and 140 hereinbefore described and shown in FIGS. 1-6, except as described hereinbelow. The low profile commercial greenhouse 220 comprises a housing 222 which has an upper end 224 and a lower end 226 which is closed, thereby forming a base 228. The housing 222 also includes a sidewall 230 which is formed of a first side 232, a second side 234, a third side 236 and a fourth side 238. The upper and lower ends 224 and 226 and the sides 232, 234, 236 and 238 of the sidewall 230 cooperate to define a plant retaining space 240 adapted to receive growing plants (such as the plants 30 shown in FIGS. 1-4), and the plant retaining space 240 is provided with a height 242 which provides a sufficient amount of spatial clearance between the upper end 224 of the housing 222 and the upper end of plants (such as the upper end 36 of plants 30 shown in FIGS. 1-4) disposed therein. The low profile commercial greenhouse 220 may also be provided with at least one aperture or port 244 in the upper end 224 of the housing 222. At least one of the sides 232, 234, 236 and 238 of the sidewall 230 of the housing 222 may also be provided with at least one aperture or port 246, such as the aperture 246 in side 234 of the sidewall 230 of the housing 222 shown in FIG. 7. The apertures 244 and 246 are substantially similar to the apertures 60 and 62 hereinbefore described with reference to the low profile commercial greenhouse 10 of FIG. 1, and may be utilized to modify the atmosphere of the plant retaining space 240 of the housing 222 of the low profile commercial greenhouse 220 in a similar manner.

The low profile commercial greenhouse 220 may be provided with a lid 248 which provides access to the plant retaining space 240 thereof, such as the lid 248 formed in the upper end 224 of the housing 222. The lid 248 may be similar to the lids 44-44a of the low profile commercial greenhouses 10-10a as described previously with reference to FIGS. 1-2. Optionally, it will be understood that the housing 222 may be provided with a door (not shown) formed in any of the sides 232, 234, 236 or 238 of the sidewall 230 of the housing 222, wherein the door would be similar to the doors 106-106a of the low profile commercial greenhouses 80-80a as described previously herein with reference to FIGS. 3-4. The lid 248 is shown attached to the low profile commercial greenhouse 220 via a hinge element 250 in FIG. 7; however, it will be understood that the lid 248 may be attached to the low profile commercial greenhouse 220 in a different manner, or the lid 248 may not be attached to the low profile commercial greenhouse 220. The lid 248 may also be used in combination with a rack disposed upon the base 228 of the housing 222 of the low profile commercial greenhouse 220 (not shown), wherein the rack may be substantially similar to any of the racks 54, 54a, 120 or 120a of the low profile commercial greenhouses 10, 10a, 80 or 80a hereinbefore described with reference to FIGS. 1-4.

The base 228 of the low profile commercial greenhouse 220 is supported on a conveyor 252 which rotates or conveys the entire low profile commercial greenhouse 220. In FIG. 7, The conveyor 252 is illustrated as comprising a rotating element 254 which rotates the low profile commercial greenhouse 220 in a fixed area in a direction indicated by the arrow 255.

FIG. 8 illustrates another embodiment of the low profile commercial greenhouse designated by the reference numeral 220a which is substantially similar to the low profile commercial greenhouse 220, except that a conveyor 252a upon which a base 228a of the low profile commercial greenhouse 220a is supported comprises a belt 256 which conveys the low profile commercial greenhouse 220a on a track in a direction indicated by the arrow 258. The track may be any shape as long as it permits uniform exposure of plants (such as the plants 30 of FIGS. 1-4) growing within a plant retaining space 240a of a housing 222a of the low profile commercial greenhouse 220a. Access to the plants disposed in the plant retaining space 240a of the housing 222a may be obtained through several mechanisms. A lid 248a in an upper end 224a of the housing 222a of the low profile commercial greenhouse 220a is shown in FIG. 8 by way of example only; however, it will be understood that the low profile commercial greenhouse 220a may be provided with a lid similar to any of the lids 44, 44a, 106 and 106a of the low profile commercial greenhouses 10, 10a, 80 and 80a illustrated in FIGS. 1-4 for obtaining access to the plant retaining space 240a of the housing 222a of the low profile commercial greenhouse 220a, and the lid may be used in combination with a rack disposed upon the base 228a of the housing 222a of the low profile commercial greenhouse 220a (not shown), wherein the rack may be substantially similar to any of the racks 54, 54a, 120 or 120a of the low profile commercial greenhouses 10, 10a, 80 or 80a hereinbefore described with reference to FIGS. 1-4.

### Description of FIGS. 9-12

Shown in FIG. 9A is a low profile commercial greenhouse 300 constructed in accordance with the present invention and which is similar to the low profile commercial greenhouses 10, 10a, 80 and 80a, except as described herein below. The low profile commercial greenhouse 300 comprises a housing 302 having a tubular or cylindrical shape. The housing 302 of the low profile commercial greenhouse 300 may be fabricated without the need for structural members, thus providing the low profile commercial greenhouse 300 with a housing 302 that is frameless. Utilizing a frameless greenhouse facilitates light transmission as well as decreases the expense associated with the greenhouse.

At least a portion of a sidewall 306 of the housing 302 of the low profile commercial greenhouse 300 may be formed of an inflatable material which, upon inflation, assumes the cylindrical or tubular shape. Shown in FIG. 9B is the low profile greenhouse 300 formed of an inflatable material and illustrated in a deflated condition. Inflatable materials from which the low profile commercial greenhouse 300 may be constructed are known in the art, and therefore no further description of such materials is required. The low profile commercial greenhouse 300 may be provided with one or more inflatable members formed horizontally or vertically in the sidewall 306 of the housing 302 thereof such that upon inflation of the inflatable members, the housing 302 assumes the cylindrical or tubular or otherwise desired shape of the low profile commercial greenhouse 300 and defines a plant retaining space 304 formed therein, as shown in FIG. 9A. The one or more inflatable members of the low profile commercial greenhouse 300 may be inflated with any gas or liquid known to a person having ordinary skill in the art. The low profile commercial greenhouse 300 may be provided with one or more valves 308 in the sidewall 306 of the housing 302 for inserting gas or liquid into the inflatable members formed therein and thus inflating the low profile commercial greenhouse 300.

Alternatively, any of the low profile commercial greenhouses described herein may be partially or wholly constructed of an inflatable material, and can assume any shape described herein, including but not by way of limitation, a polygonal shape. The use of an inflatable material for the construction of the low profile commercial greenhouse has several advantages, including increased light transmission and decreased expense as described herein above, as well as producing a lightweight, portable greenhouse that can easily be moved or transported the low profile commercial greenhouse from one position to another position, whether in a deflated or an inflated condition. In addition, the use of various light filtering, light absorbing or light spectrum modulating gases or liquids in the inflation of the low profile commercial greenhouse will provide different mechanisms by which the transmission of light to plants within the low profile commercial greenhouse can be controlled.

When the low profile commercial greenhouse 300 is constructed of an inflatable material, the housing 302 may be sealable such that the housing 302 is substantially liquid and gas impermeable as described herein before, and the plant retaining space 304 of the inflatable low profile commercial greenhouse 300 may be pressurized or unpressurized. The plant retaining space 304 of the inflatable low profile commercial greenhouse 300 may be pressurized with any gas or liquid known to a person having ordinary skill in the art.

The low profile commercial greenhouse 300 may further be provided with an area that allows for insertion of a cover or curtain. The cover or curtain may be inserted interiorly or exteriorly to the housing 302 of the low profile commercial greenhouse 300. Such cover or curtain provides a method for shading the greenhouse when desired, as described herein before for the purposes of providing plants with a period of darkness and for bloom-forcing out of season in flowering plants. The cover or curtain may be detachable from the low profile commercial greenhouse 300, or the cover or curtain may be integral to the low profile commercial greenhouse 300.

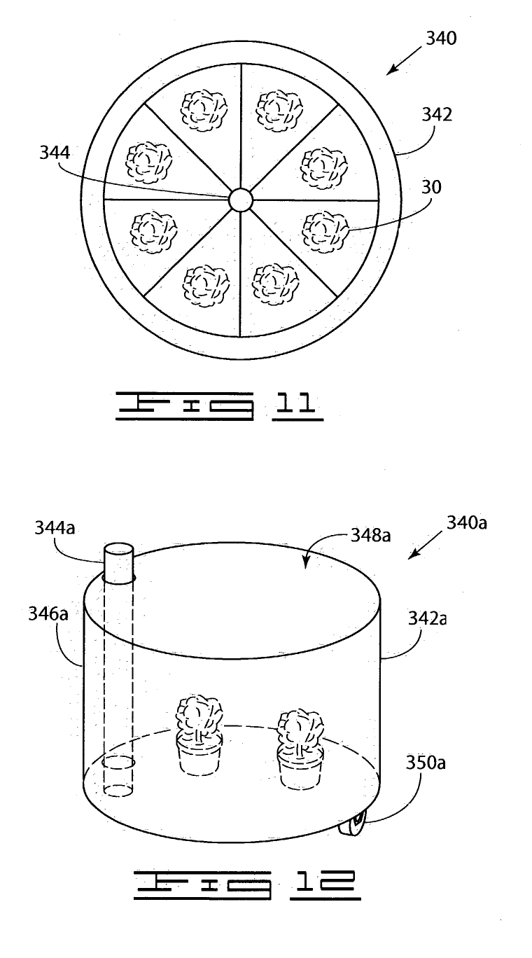

Shown in FIG. 10 is another low profile commercial greenhouse 320 constructed in accordance with the present invention and which is similar to the low profile commercial greenhouses 10, 10a, 80 and 80a, except as described herein below. The low profile commercial greenhouse 320 comprises a housing 322 having a polygonal shape, such as an octagon, as shown in FIG. 10. However, it is to be understood that the housing 322 of the low profile commercial greenhouse 320 may be provided with any polygonal shape, such as but not by way of limitation, triangle, square, rectangle, quadrilateral, paralellogram, rhombus, trapezoid, pentagon, hexagon, heptagon, nonagon, decagon and the like shapes, and an octagonal shape is shown in FIG. 10 for purposes of example only.

Shown in FIG. 11 is a cross-section of a low profile commercial greenhouse 340 constructed in accordance with the present invention and which is similar to the low profile commercial greenhouses 10, 10a, 80, 80a and 320, except as described herein below. The low profile commercial greenhouse 340 is illustrated as having a housing 342 having a cylindrical or tubular shape; however, it is to be understood that the housing 342 of the low profile commercial greenhouse 340 may be provided with any polygonal shape, as described herein above.

Rather than providing a conveyor system for rotation of plants in the low profile commercial greenhouse 340, the housing 342 of the low profile commercial greenhouse 340 is itself rotatable, wherein the low profile commercial greenhouse may be rotated from one position to a second position when it is desired to rotate the plants contained therein.

The housing 342 of the low profile commercial greenhouse 340 is provided with a central portion or hub 344 around which the housing 342 of the low profile commercial greenhouse 340 rotates. In this manner, a plant 30 or other organism located in one portion of the housing 342 of the low profile commercial greenhouse 340 may be rotated to another position within the housing 342 to provide a more uniform exposure of each plant 30 or organism disposed in the low profile commercial greenhouse 340 to sunlight and allowing the plants 30 or other organisms to mature at a more uniform rate. The hub 344 may be provided at any position within the housing 342 or attached to the housing 342 of the low profile commercial greenhouse 340, and locating the hub 344 at a central position is shown in FIG. 11 for the purposes of illustration only.

The low profile commercial greenhouse 340 may further be provided with one or more wheels, at least a portion of which extend below the low profile commercial greenhouse 340 and aid an operator in rotating the low profile commercial greenhouse 340. Illustrated in FIG. 12 is a low profile commercial greenhouse 340a similar to the low profile commercial greenhouse 340 described herein above, except that the low profile commercial greenhouse 340a is provided with a hub 344a located near or adjacent to a sidewall 346a of a housing 342a of the low profile commercial greenhouse 340a. The hub 344a may be attached to the sidewall 346a, or located at any position in a plant retaining space 348a of the low profile commercial greenhouse 340a. The low profile commercial greenhouse 340a rotates around the hub 344a, and is illustrated as being provided with one or more wheels 350a (one wheel shown in FIG. 12 for the purposes of illustration only) that aids in rotational movement and stabilization of the low profile commercial greenhouse 340a. Optionally, the low profile commercial greenhouse 340a may not be provided with a hub 344a, and the one or more wheels 350a allow for moving or rotating the low profile commercial greenhouse 340a such that plants or organisms disposed therein are provided with more uniform exposure to sunlight and allowed to mature at a more uniform rate.

While a rotating greenhouse has been shown in FIG. 11, it will be understood that any configuration of forming the low profile commercial greenhouse 340 such that at least a portion of the low profile commercial greenhouse 340 may be moved from one position to another position falls within the scope of the present invention, and a rotating greenhouse has been shown herein for purposes of illustration only.

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and as defined in the appended claims.

What is claimed is:

1. A low profile commercial greenhouse adapted for growing plants, comprising:
a housing having an upper end, a lower end and a polygonal or cylindrical shape, the housing defining a plant retaining space adapted to receive growing plants, the plant retaining space having a height sufficient to provide a predetermined amount of spatial clearance between the upper end of the housing and an upper end of plants growing therein to permit circulation of air and other fluids about at least a portion of the plants growing therein.

2. The low profile commercial greenhouse of claim 1 wherein the lower end of the housing is closed, thereby forming a base.

3. The low profile commercial greenhouse of claim 2 further comprising a conveyor system disposed in the plant retaining space of the housing such that plants disposed on the conveyor system can be moved in the plant retaining space and to enhance insertion and/or removal of the plants from the plant retaining space of the housing of the low profile commercial greenhouse.

4. The low profile commercial greenhouse of claim 3 wherein the housing is provided with at least one opening through which the conveyor system extends, thereby providing an entry and/or an exit for plants from the plant retaining space of the housing of the low profile commercial greenhouse.

5. The low profile commercial greenhouse of claim 1 wherein the upper end of the housing is further defined as a light-transmitting upper end.

6. The low profile commercial greenhouse of claim 1 wherein the upper end of the housing is further defined as a closed upper end, and wherein at least a portion of the closed upper end is light-transmitting.

7. The low profile commercial greenhouse of claim 1 wherein at least a portion of the upper end is movable independently of the rest of the housing, thereby forming a lid or door which provides an individual access to the plant retaining space of the housing.

8. The low profile commercial greenhouse of claim 1 wherein the housing is sealed such that the housing is substantially gas and liquid impermeable, whereby the plant retaining space of the housing is provided with an atmosphere disposed therein.

9. The low profile commercial greenhouse of claim 8 wherein the housing is provided with at least one aperture whereby the atmosphere provided in the plant retaining space of the housing may be modified by at least one of injecting a disinfectant, injecting water, varying oxygen, carbon dioxide, nitrogen and/or other gas concentrations, varying temperature, varying humidity, varying intensity of light or spectrum of light from natural sources, and combinations thereof.

10. The low profile commercial greenhouse of claim 1 wherein the housing is substantially gas permeable, and the plant retaining space of the housing is provided with an atmosphere disposed therein wherein the atmosphere provided in the plant retaining space of the housing may be modified by at least one of injecting a disinfectant, injecting water, injecting nutrients, varying oxygen, carbon dioxide, nitrogen and/or other gas concentrations, varying temperature, varying humidity, varying intensity of light or spectrum of light from natural sources, and combinations thereof.

11. The low profile commercial greenhouse of claim 10 wherein the housing is substantially liquid impermeable.

12. The low profile commercial greenhouse of claim 10 wherein the housing is liquid permeable.

13. The low profile commercial greenhouse of claim 1 wherein artificial lighting is provided in the housing, and wherein intensity of light and spectrum of light from the artificial light source can be varied within the housing of the low profile commercial greenhouse.

14. The low profile commercial greenhouse of claim 1 wherein the housing has a cylindrical shape.

15. The low profile commercial greenhouse of claim 1 wherein at least a portion of a sidewall of the housing of the low profile commercial greenhouse is inflatable.

16. The low profile commercial greenhouse of claim 1 wherein at least a portion of the housing of the low profile commercial greenhouse is rotatable.

17. A low profile commercial greenhouse adapted for growing plants, comprising:
a housing having an upper end, a lower end and a polygonal or cylindrical shape, the housing defining a plant retaining space adapted to receive growing plants, the plant retaining space having a height sufficient to provide a predetermined amount of spatial clearance between the upper end of the housing and an upper end of plants growing therein to permit circulation of air and other fluids about at least a portion of the plants growing therein;
a conveyor system disposed in the plant retaining space of the housing such that plants disposed on the conveyor system can be moved in the plant retaining space and to enhance insertion and/or removal of plants from the plant retaining space of the housing of the low profile commercial greenhouse.

18. The low profile commercial greenhouse of claim 17 wherein the upper end of the housing is further defined as a light-transmitting upper end.

19. The low profile commercial greenhouse of claim 17 wherein the housing is provided with at least one opening through which the conveyor system extends, thereby providing an entry and/or an exit for plants from the plant retaining space of the housing of the low profile commercial greenhouse.

20. The low profile commercial greenhouse of claim 17 wherein the housing is sealed such that the plant retaining space is substantially gas and liquid impermeable, whereby the plant retaining space is provided with an atmosphere disposed therein.

21. The low profile commercial greenhouse of claim 20 wherein the housing is provided with at least one aperture whereby the atmosphere provided in the plant retaining space of the housing may be modified by at least one of injecting a disinfectant, injecting water, injecting nutrients, varying oxygen, carbon dioxide, nitrogen and/or other gas concentrations, varying temperature, varying humidity, varying intensity of light or spectrum of light from natural sources, and combinations thereof.

22. The low profile commercial greenhouse of claim 17 wherein the housing is substantially gas permeable, and the plant retaining space of the housing is provided with an atmosphere disposed therein wherein the atmosphere provided in the plant retaining space of the housing may be modified by at least one of injecting a disinfectant, injecting water, injecting nutrients, varying oxygen, carbon dioxide, nitrogen and/or other gas concentrations, varying temperature, varying humidity, varying intensity of light or spectrum of light from natural sources, and combinations thereof.

23. The low profile commercial greenhouse of claim 22 wherein the housing is substantially liquid impermeable.

24. The low profile commercial greenhouse of claim 22 wherein the housing is liquid permeable.

25. The low profile commercial greenhouse of claim 17 wherein an artificial light source is provided in the housing, and wherein intensity of light and spectrum of light from the artificial light source can be varied within the housing of the low profile commercial greenhouse.

26. The low profile commercial greenhouse of claim 17 wherein the housing has a cylindrical shape.

27. The low profile commercial greenhouse of claim 17 wherein at least a portion of a sidewall of the housing of the low profile commercial greenhouse is inflatable.

28. A method for growing plants, comprising:
providing a low profile commercial greenhouse comprising a housing having an upper end and a lower end, the housing having a polygonal or cylindrical shape, the housing defining a plant retaining space adapted to receive growing plants, the plant retaining space having a height sufficient to provide a predetermined amount of spatial clearance between the upper end of the housing and an upper end of plants growing therein to permit circulation of air and other fluids about at least a portion of the plants growing therein;
providing a plant to be grown therein;
disposing the plant in the plant retaining space of the housing;
feeding and watering the plant growing within the low profile commercial greenhouse until the plant matures to a marketable size; and
removing the plant from the housing of the low profile commercial greenhouse.

29. The method of growing plants of claim 28 wherein, in the step of providing a low profile commercial greenhouse, the lower end of the housing is closed, thereby forming a base.

30. The method of growing plants of claim 28 wherein, in the step of providing a low profile commercial greenhouse, the upper end of the housing is light-transmitting.

31. The method of growing plants of claim 28 wherein, in the steps of providing a low profile commercial greenhouse, disposing the plant in the plant retaining space of the housing and removing the plant from the housing of the low profile commercial greenhouse, at least a portion of the housing is movable independently of the rest of the housing, thereby forming a lid or door which provides an individual access to the plant retaining space of the housing for disposing and removing the plant from the plant retaining space of the housing of the low profile commercial greenhouse.

32. The method of growing plants of claim 28 wherein the step of disposing the plant in the plant retaining space of the housing further comprises sealing the housing such that the housing is substantially gas and liquid impermeable whereby the plant retaining space of the housing is provided with an atmosphere disposed therein.

33. The method of growing plants of claim 32 wherein, in the step of providing a low profile commercial greenhouse, the housing is provided with at least one aperture whereby the atmosphere provided in the plant retaining space of the housing may be modified by at least one of injecting a disinfectant, injecting water, injecting nutrients, varying oxygen, carbon dioxide, nitrogen and/or other gas concentrations, varying temperature, varying humidity, varying intensity of light or spectrum of light from natural sources and combinations thereof.

34. The method of growing plants of claim 28 wherein, in the step of providing a low profile commercial greenhouse, the housing is substantially gas permeable, and the plant retaining space of the housing is provided with an atmosphere disposed therein wherein the atmosphere provided in the plant retaining space may be modified by at least one of injecting a disinfectant, injecting water, varying oxygen, carbon dioxide, nitrogen and/or other gas concentrations, varying temperature, varying humidity, varying intensity of light or spectrum of light from natural sources and combinations thereof.

35. The method of growing plants of claim 34 wherein, in the step of providing a low profile commercial greenhouse, the housing is liquid permeable.

36. The method of growing plants of claim 34 wherein, in the step of providing a low profile commercial greenhouse, the housing is substantially liquid impermeable.

37. The method of growing plants of claim 28 wherein, in the step of providing a low profile commercial greenhouse, an artificial light source is provided in the housing, and wherein intensity of light and spectrum of light from the artificial light source can be varied within the housing of the low profile commercial greenhouse.

38. The method of growing plants of claim 28 wherein, in the step of providing a low profile commercial greenhouse, the low profile commercial greenhouse further comprises a conveyor system disposed in the plant retaining space of the housing such that plants disposed on the conveyor system can be moved in the plant retaining space and to enhance insertion and/or removal of plants from the plant retaining space of the housing of the low profile commercial greenhouse.

39. The method of growing plants of claim 38 wherein the housing is provided with at least one opening through which the conveyor system extends, thereby providing an entry and/or an exit for plants from the plant retaining space of the housing of the low profile commercial greenhouse.

40. The method of growing plants of claim 28 wherein, in the step of providing a low profile commercial greenhouse, the housing has a cylindrical shape.

41. The method of growing plants of claim 28 wherein, in the step of providing a low profile commercial greenhouse, at least a portion of a sidewall of the housing of the low profile commercial greenhouse is inflatable.

42. The method of growing plants of claim 28 wherein at least a portion of the housing of the low profile commercial greenhouse is rotatable, and wherein the step of feeding and watering the plant growing within the low profile commercial greenhouse until the plant matures to a marketable size further comprises rotating the plant growing within the low profile commercial greenhouse, thereby providing a more uniform exposure of the plant disposed in the low profile commercial greenhouse to sunlight.

43. The method of growing plants of claim 28 wherein, in the step of providing a plant, the plant is selected from the group consisting of botanical items, propagules, vegetables, flowers, herbs, mushrooms, cultures, organisms, and combinations thereof.

44. A method for growing plants, comprising:
providing a low profile commercial greenhouse comprising a housing having an upper end and a lower end, the housing having a polygonal or cylindrical shape, the housing defining a plant retaining space adapted to receive growing plants, the plant retaining space having a height sufficient to provide a predetermined amount of spatial clearance between the upper end of the housing and an upper end of plants growing therein to permit circulation of air and other fluids about at least a portion of the plants growing therein, the low profile commercial greenhouse further comprising a conveyor system disposed in the plant retaining space of the housing such that plants disposed on the conveyor system can be moved in the plant retaining space and to enhance insertion and/or removal of plants from the plant retaining space of the housing of the low profile commercial greenhouse, and wherein at least a portion of the housing is movable independently of the rest of the housing, thereby forming a lid or door which provides an individual access to the plant retaining space of the housing;
providing a plant to be grown therein;
disposing the plant in the plant retaining space of the housing through the lid or door in the housing;
conveying the plant within the plant retaining space of the housing such that the plant receives adequate exposure to light;
feeding and watering the plant growing within the low profile commercial greenhouse until the plant matures to a marketable size; and
removing the plant from the plant retaining space of the housing of the low profile commercial greenhouse.

45. The method of growing plants of claim 44 wherein, in the step of providing a low profile commercial greenhouse, the upper end of the housing is light-transmitting.

46. The method of growing plants of claim 44 wherein the step of disposing the plant in the plant retaining space of the housing further comprises sealing the housing such that the housing is substantially gas and liquid impermeable and whereby the plant retaining space of the housing is provided with an atmosphere disposed therein.

47. The method of growing plants of claim 46 wherein, in the step of providing a low profile commercial greenhouse, the housing is provided with at least one aperture whereby the atmosphere provided in the plant retaining space of the housing may be modified by at least one of injecting a disinfectant, injecting water, varying oxygen, carbon dioxide, nitrogen and/or other gas concentrations, varying temperature, varying humidity, varying intensity of light or spectrum of light from natural sources and combinations thereof.

48. The method of growing plants of claim 44 wherein, in the step of providing a low profile commercial greenhouse, the housing is substantially gas permeable, and the plant retaining space of the housing is provided with an atmosphere disposed therein wherein the atmosphere provided in the plant retaining space may be modified by at least one of injecting a disinfectant, injecting water, varying oxygen, carbon dioxide, nitrogen and/or other gas concentrations, varying temperature, varying humidity, varying intensity of light or spectrum of light from natural sources and combinations thereof.

49. The method of growing plants of claim 48 wherein, in the step of providing a low profile commercial greenhouse, the housing is substantially liquid impermeable.

50. The method of growing plants of claim 48 wherein, in the step of providing a low profile commercial greenhouse, the housing is liquid permeable.

51. The method of growing plants of claim 44 wherein, in the step of providing a low profile commercial greenhouse, an artificial light source is provided in the housing, and wherein intensity of light and spectrum of light from the artificial light source can be varied within the housing of the low profile commercial greenhouse.

52. The method of growing plants of claim 44 wherein, in the step of providing a low profile commercial greenhouse, the housing is provided with at least one opening through which the conveyor system extends, thereby providing an entry and/or an exit for plants from the plant retaining space of the housing of the low profile commercial greenhouse.

53. The method of growing plants of claim 44 wherein, in the step of providing a low profile commercial greenhouse, the housing has a cylindrical shape.

54. The method of growing plants of claim 44 wherein, in the step of providing a low profile commercial greenhouse, at least a portion of a sidewall of the housing of the low profile commercial greenhouse is inflatable.

55. The method of growing plants of claim 44 wherein, in the step of providing a plant, the plant is selected from the group consisting of botanical items, propagules, vegetables, flowers, herbs, mushrooms, cultures, organisms, and combinations thereof.
